(19) United States
(12) Patent Application Publication
(10) Pub. No.: US 2026/0320493 A1
(43) Pub. Date: Oct. 15, 2026

(54) DIFFERENTIABLE SHOT NOISE STATE VECTOR SIMULATION

(71) Applicant: IonQ, Inc., College Park, MD (US)

(72) Inventors: Jonathan MEI, Jersey City, NJ (US); Shang H. KIM, La Canada Flintridge, CA (US); Masako YAMADA, Niskayuna, NY (US); Martin ROETTELER, Woodinville, WA (US)

(21) Appl. No.: 19/644,776

(22) Filed: Apr. 10, 2026

Related U.S. Application Data
(60) Provisional application No. 63/787,436, filed on Apr. 11, 2025.

(51) Int. Cl. G06N 20/00; G06N 10/20; G06N 10/40

(52) U.S. Cl. CPC G06N 20/00; G06N 10/20; G06N 10/40

(57) ABSTRACT

The present disclosure introduces a differentiable framework for modeling quantum shot noise in state vector simulations used for training parameterized quantum circuits. Conventional approaches rely on multinomial sampling of measurement outcomes, which is inherently discrete and non-differentiable, blocking gradient-based optimization. To address this, the present disclosure replaces multinomial sampling with a continuous approximation using a multivariate Gaussian distribution that captures the statistical properties of shot noise. By applying a reparameterization technique, stochastic noise is expressed as a deterministic function of circuit parameters and auxiliary random variables, enabling gradients to propagate through the noise model. The method integrates noise directly into the quantum state vector, followed by normalization to maintain physical validity. This approach preserves differentiability while incorporating realistic noise effects, allowing efficient end-to-end training using standard optimization methods. The result is a scalable, noise-aware simulation framework that improves the fidelity and practicality of quantum machine learning development.

### CROSS REFERENCE TO RELATED APPLICATIONS

The current application claims priority to U.S. Patent Provisional Application No. 63/787,436, filed Apr. 11, 2025, the entire contents of which are hereby incorporated by reference.

### TECHNICAL FIELD

Aspects of the present disclosure relate generally to systems and methods for use in the implementation and/or operation of quantum information processing (QIP) systems.

### BACKGROUND

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, and/or control of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

The present disclosure describes systems and methods for differentiably simulating quantum measurement shot noise in the measurement output space, after outcome probabilities have been computed from a simulated quantum state vector, enabling gradient-based training of quantum machine learning models. As used herein, this simulation emulates the stochasticity of quantum measurements at the level of sampled outcomes or counts, rather than by perturbing the underlying state vector; probabilities are first derived from the state, and shot noise is then introduced through sampling or approximations of measurement results. Because such sampling is inherently non-differentiable, differentiable approximations—such as reparameterization, continuous relaxations, or surrogate losses—are applied in the measurement output space to estimate gradients while preserving the statistical properties of measurement noise.

The present disclosure begins by modeling measurement outcomes as samples from a multinomial distribution, reflecting the probabilistic nature of quantum measurements at finite shot counts. At high shot counts, this multinomial distribution is approximated by a multivariate Gaussian with a degenerate covariance matrix to capture the inherent constraint that outcome probabilities must sum to one. To enable differentiation through the sampling process, the method applies the reparameterization trick—transforming samples from the Gaussian using standard normal variables and distribution parameters—thereby making the process compatible with automatic differentiation. This reparameterized sampling is integrated into a quantum state vector simulator, allowing for realistic and differentiable modeling of measurement noise. As a result, the present disclosure supports backpropagation through quantum simulations, facilitating the development and optimization of quantum machine learning algorithms.

In some aspects, the techniques described herein relate to a method for training a parameterized quantum circuit using noise-aware optimization. The method including: receiving, by one or more processors, a parameterized quantum circuit having a plurality of trainable parameters executable on a quantum processing unit (QPU); simulating, by a state vector simulator executed on the one or more processors, an output quantum state of the parameterized quantum circuit based on the plurality of trainable parameters, wherein the output quantum state is represented as a state vector representation; determining, by the one or more processors, a probability distribution associated with measurement outcomes of the state vector representation; approximating a multinomial measurement distribution associated with the measurement outcomes with a differentiable continuous distribution based on the probability distribution; generating a noise sample as a differentiable function of the plurality of trainable parameters and one or more auxiliary random variables; modifying, by the one or more processors, an expected measurement output vector by additively combining the noise sample with the expected measurement output vector to produce a noisy measurement output vector, wherein the expected measurement output vector is derived from the probability distribution scaled by a number of measurement shots; computing one or more observables and a loss function based on the noisy measurement output vector; and updating the plurality of trainable parameters using gradients of the loss function with respect to the plurality of trainable parameters, wherein the gradients are computed via backpropagation through the differentiable continuous distribution.

In some aspects, the techniques described herein relate to a system for training a parameterized quantum circuit using noise-aware optimization. The system including at least one or more processors; and a memory storing instructions that, when executed by the one or more processors, cause the system to: receive, by one or more processors, a parameterized quantum circuit having a plurality of trainable parameters executable on a quantum processing unit (QPU); simulate, by a state vector simulator executed on the one or more processors, an output quantum state of the parameterized quantum circuit based on the plurality of trainable parameters, wherein the output quantum state is represented as a state vector representation; determine, by the one or more processors, a probability distribution associated with measurement outcomes of the state vector representation; approximate a multinomial measurement distribution associated with the measurement outcomes with a differentiable continuous distribution based on the probability distribution; generate a noise sample as a differentiable function of the plurality of trainable parameters and one or more auxiliary random variables; modify, by the one or more processors, an expected measurement output vector by additively combining the noise sample with the expected measurement output vector to produce a noisy measurement output vector, wherein the expected measurement output vector is derived from the probability distribution scaled by a number of measurement shots; compute one or more observables and a loss function based on the noisy measurement output vector; and update the plurality of trainable parameters using gradients of the loss function with respect to the plurality of trainable parameters, wherein the gradients are computed via backpropagation through the differentiable continuous distribution.

In some aspects, the techniques described herein relate to a hybrid classical-quantum system for training a parameterized quantum circuit using noise-aware optimization. The hybrid classical-quantum system including: a classical computing system including one or more processors and memory storing instructions; and a quantum processing unit (QPU) configured to execute the parameterized quantum circuit, wherein the classical computing system is configured to: receive, by one or more processors, a parameterized quantum circuit having a plurality of trainable parameters executable on the QPU; simulate, by a state vector simulator executed on the one or more processors, an output quantum state of the parameterized quantum circuit based on the plurality of trainable parameters, wherein the output quantum state is represented as a state vector representation; determine, by the one or more processors, a probability distribution associated with measurement outcomes of the state vector representation; approximate a multinomial measurement distribution associated with the measurement outcomes with a differentiable continuous distribution based on the probability distribution; generate a noise sample as a differentiable function of the plurality of trainable parameters and one or more auxiliary random variables; modify, by the one or more processors, an expected measurement output vector by additively combining the noise sample with the expected measurement output vector to produce a noisy measurement output vector, wherein the expected measurement output vector is derived from the probability distribution scaled by a number of measurement shots; compute one or more observables and a loss function based on the noisy measurement output vector; and update the plurality of trainable parameters using gradients of the loss function with respect to the plurality of trainable parameters, wherein the gradients are computed via backpropagation through the differentiable continuous distribution.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions in a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates a diagram of simulating shot noise from a quantum circuit via sampling from the exact multinomial distribution in accordance with aspects of this disclosure.

FIG. 5 illustrates a diagram of approximately simulating shot noise from a quantum circuit via reparameterization using the infinite shot count limit distribution in accordance with aspects of this disclosure.

FIG. 6 illustrates a block diagram of a hybrid quantum-classical architecture for fine-tuning a large language model (LLM) using a parameterized quantum circuit in accordance with aspects of this disclosure.

FIG. 7 illustrates a method for differentiably simulating shot noise from a quantum circuit in accordance with aspects of this disclosure.

FIG. 8 illustrates an example of a QIP system in accordance with aspects of this disclosure.

Like reference numbers and designations in the various drawings indicate like elements.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

Since the modern resurgence of neural networks in machine learning, differentiable computation has become a central theme in algorithm development, enabling powerful optimization techniques such as backpropagation and gradient descent. In the emerging field of quantum machine learning, differentiable programming is equally desirable, as it allows for the training of hybrid quantum-classical models using familiar optimization pipelines. To support this, quantum simulation frameworks have become essential tools, enabling researchers to prototype and evaluate quantum algorithms in silico before deploying them to real quantum hardware.

However, differentiable simulation of quantum systems presents unique challenges. One notable difficulty lies in modeling the statistical noise introduced by quantum measurement—commonly referred to as shot noise. Because quantum measurements yield probabilistic outcomes, simulating this process typically involves sampling from discrete distributions, such as the multinomial distribution. Unfortunately, these discrete sampling steps are not naturally differentiable, which complicates efforts to integrate realistic quantum measurement behavior into gradient-based learning workflows.

The present disclosure leverages a reparameterization technique to enable differentiable simulation of multinomially distributed quantum shot noise at high shot counts. In the described differentiable path, the discrete sampling step is replaced by a differentiable approximation, for example by approximating the multinomial distribution with a multivariate Gaussian in the infinite shot count limit, thereby providing a tractable surrogate that captures the statistical behavior of shot noise. The noise is introduced as an additive component in the measurement output space-after probabilities or expectation values have been computed from the simulated quantum state vector-rather than as a non-differentiable module within the gradient path. This formulation preserves gradient flow for backpropagation through the differentiable components of the model while incorporating realistic measurement noise. As a result, the approach enables scalable, gradient-based optimization for quantum machine learning algorithms while maintaining computational efficiency and physical fidelity.

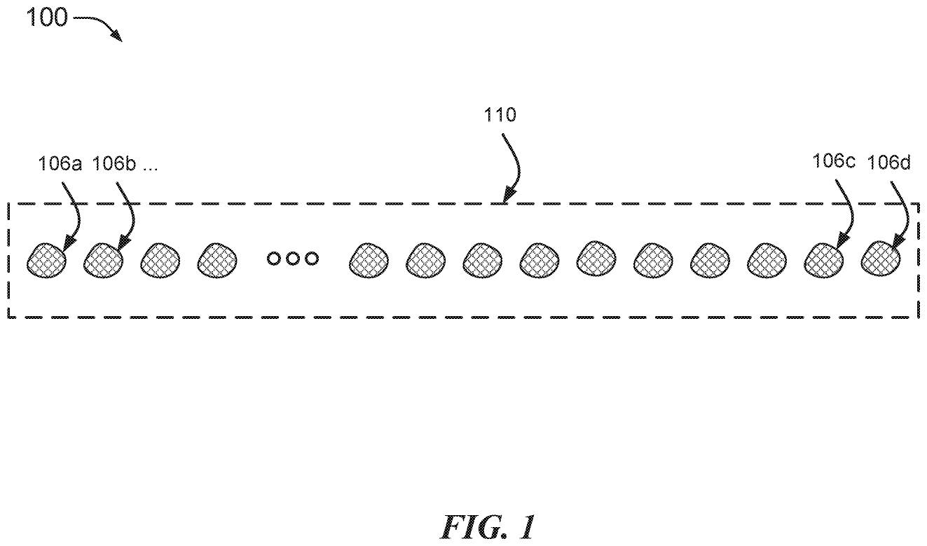

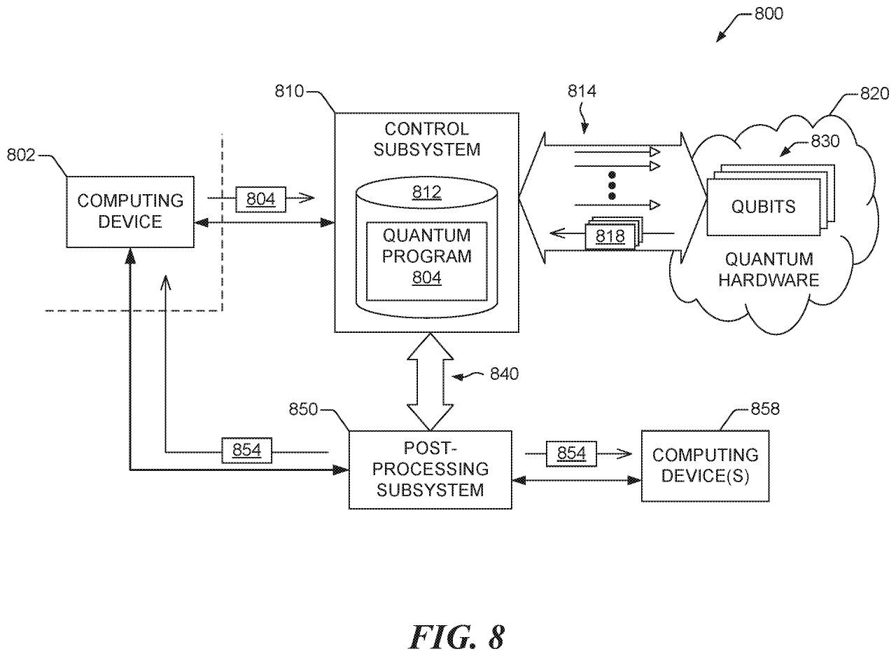

Solutions to the issues described above are explained in more detail in connection with FIGS. 1-8, with FIGS. 1-3 providing a general description of an exemplary QIP system or quantum computer, and more specifically, of atomic-based QIP systems or quantum computers, which can be configured to implement the systems and methods described herein. In addition, FIG. 8 illustrates a QIP system on which aspects of systems and methods for differentiably simulating quantum measurement shot noise according to aspects of the present disclosure.

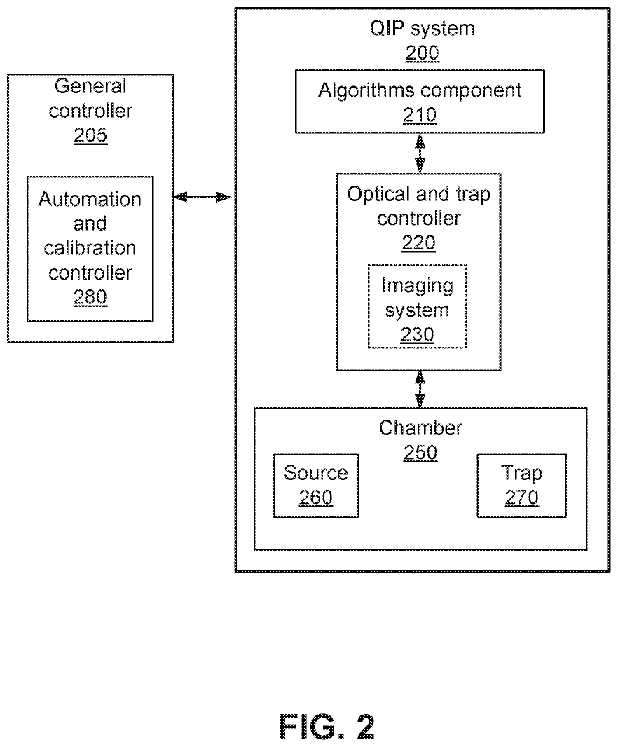

FIG. 1 illustrates a diagram 100 with multiple atomic ions or ions 106 (e.g., atomic ions 106a, 106b, . . . , 106c, and 106d) trapped in a linear crystal or chain 110 using a trap (the trap can be inside a vacuum chamber as shown in FIG. 2). The trap may be referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110. Some or all of the ions 106 may be configured to operate as qubits in a QIP system.

In the example shown in FIG. 1, the trap includes electrodes for trapping or confining multiple atomic ions (e.g., a plurality of ions) into the chain 110 that are laser-cooled to be nearly at rest. The number of atomic ions (N) trapped can be configurable and more or fewer atomic ions may be trapped. The atomic ions can be Ytterbium ions (e.g., 171Yb+ ions), for example. The atomic ions are illuminated with laser (optical) radiation tuned to a resonance in 171Yb+ and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and does not need to be uniform. Moreover, in addition to atomic Ytterbium ions, neutral atoms, Rydberg atoms, different atomic ions or different species of atomic ions may also be used. The trap may be a linear RF Paul trap, but other types of confinement may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

As will be described in detail below, and according to an exemplary aspect, the ions in the ion trap can be configured by applying a laser (e.g., a Raman configuration) to one or more of the plurality of qubits to set a probability of a single event by rotating the one or more qubits to fix a relative angle of the at least one qubit. These details will be described below.

FIG. 2 is a block diagram that illustrates an example of a QIP system 200 in accordance with various aspects of this disclosure. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations, and the hybrid computing system also includes a classical computer to perform classical computations and operations.

Shown in FIG. 2 is a general controller 205 configured to perform various control operations of the QIP system 200, including the methods and algorithms described herein. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. The algorithms component 210 may also include software tools (e.g., compilers) that facilitate such performance or implementation. As such, the algorithms component 210 may provide, directly or indirectly, instructions to various components of the QIP system 200 (e.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include an optical and trap controller 220 that controls various aspects of a trap 270 in a chamber 250, including the generation of signals to control the trap 270, and controls the operation of lasers and optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions or different species of atomic ions. The lasers and optical systems (e.g., optical sources) can be at least partially located in the optical and trap controller 220 and/or in the chamber 250. For example, optical systems within the chamber 250 may refer to optical components or optical assemblies. The optical and trap controller 220 can be configured to generate one or more lasers to rotate the ions and set a probability of the respective events associated with each qubit. For example, optical sources of the optical and trap controller 220 can be configured for ionization of the atomic species, control (e.g., phase control) of the atomic ions, and for fluorescence of the atomic ions that can be monitored and tracked by image processing algorithms operating in an imaging system 230, for example.

More particularly, the QIP system 200 can include an imaging system 230 that may comprise a high-resolution imager (e.g., CCD camera) or other type of detection device (e.g., photomultiplier tube or PMT) for monitoring the atomic ions while they are being provided to the trap 270 and/or after they have been provided to the trap 270. In an aspect, the imaging system 230 can be implemented separate from the optical and trap controller 220, however, the use of fluorescence to detect, identify, and label atomic ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of a processor or processing portion of the QIP system 200. That is, the trap 270 may be considered at the core of the processing operations of the QIP system 200 since it holds the atomic-based qubits that are used to perform the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the general controller 205, the automation and calibration controller 280, and/or the algorithms component 210. These and/or other components of the QIP system 200 may be used in connection with the techniques for differentiably simulating quantum measurement shot noise.

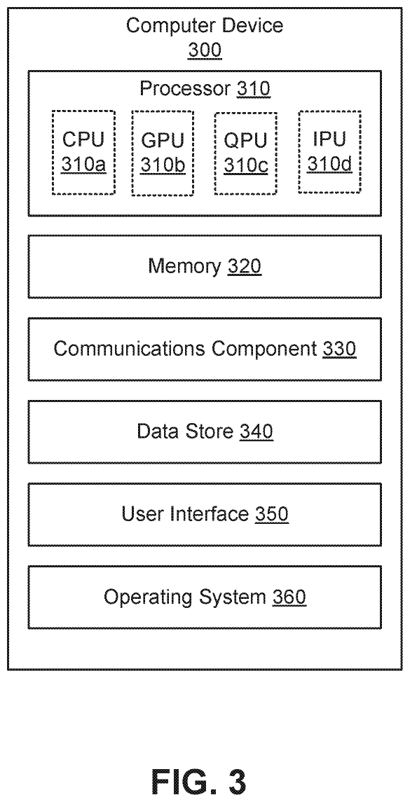

FIG. 3 illustrates an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single or multiple set of processors or multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

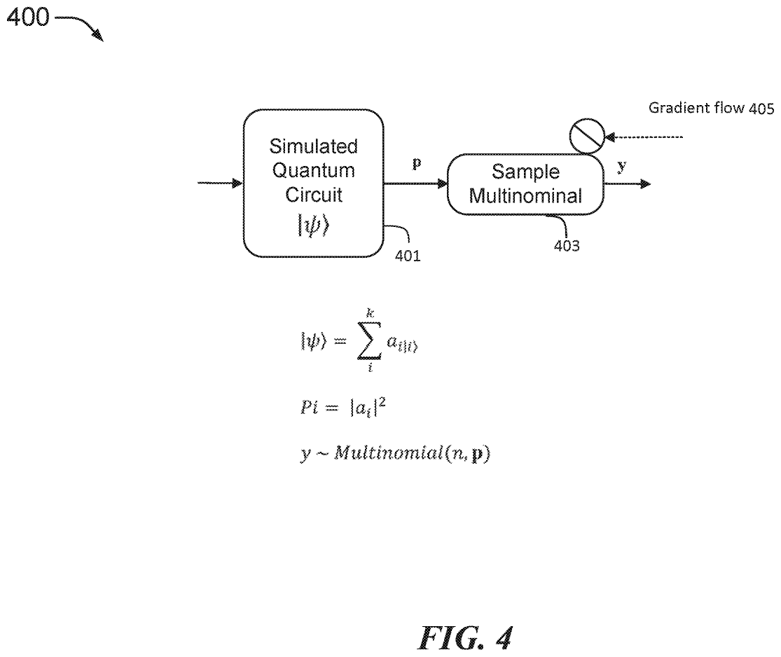

In connection with the systems described in FIGS. 1-3 and 8, and with further details provided in FIGS. 4-7, the present disclosure provides various aspects of techniques for simulating differentiable quantum measurement shot noise for use in quantum machine learning model development.

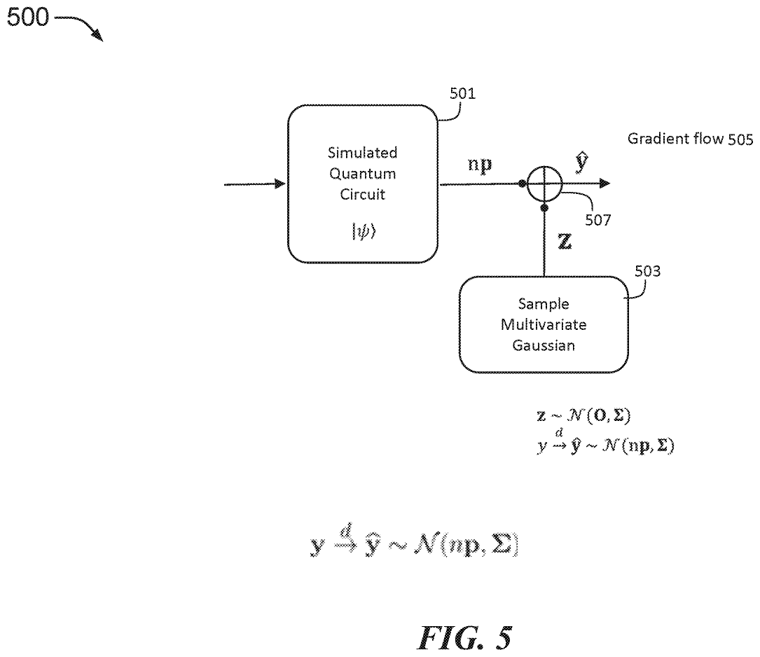

As will be described in more detail below, FIGS. 4-7 expand upon the system architecture and operational systems described in FIGS. 2-3 by detailing the specific process of simulating shot noise from a quantum circuit. FIGS. 2 and 3 provide an overview of the QIP system and its computational architecture, including components like the general controller, quantum processors, and memory modules. FIGS. 5-7 build upon this by illustrating how these components interact to achieve a core system capable of differentiably simulating the multinomial distributed shot noise at high shot counts. FIG. 8 describes a QIP system on which aspects of the present disclosure may be implemented. Together, these figures describe the system-level claims with detailed operational workflows, highlighting the ability to differentiably simulate quantum measurement shot noise for use in quantum machine learning model development.

In recent years, the widespread adoption of neural networks in machine learning has established differentiable computation as a fundamental component for optimizing models via gradient-based methods. In the field of quantum machine learning, where hybrid quantum-classical architectures are commonly employed, it is necessary to utilize quantum simulation frameworks that support the computation of gradients with respect to quantum circuit parameters. Such frameworks are critical for the efficient design, testing, and deployment of quantum algorithms. However, differentiable simulation of quantum systems presents technical challenges, primarily due to the inherently probabilistic and discrete nature of quantum measurements. One significant challenge involves modeling shot noise (i.e., the statistical fluctuations resulting from the finite sampling of quantum measurements) in a manner that preserves compatibility with gradient-based optimization. Traditional methods of incorporating shot noise introduce non-differentiable operations, thereby disrupting the backpropagation of gradients through the computational graph. Accordingly, there exists a need for systems and methods that enable accurate, tractable, and differentiable simulation of shot noise within quantum machine learning frameworks, facilitating more realistic and efficient algorithm development.

FIG. 4 illustrates a diagram of simulating shot noise from a quantum circuit via sampling from the exact multinomial distribution in accordance with aspects of this disclosure. Specifically, example 400 illustrates the simulation of shot noise in a quantum circuit by directly sampling from the exact multinomial distribution. As an example, referring back to FIGS. 1-3, the operations illustrated in FIG. 4 may be implemented by one or more processors, such as processor 310 of the computer device 300, in coordination with memory 320 and the algorithms component 210. The simulated quantum circuit 401 may be executed by the algorithms component 210 and/or processor 310 to perform state vector-based simulation and generate a corresponding probability distribution. The sample multinomial operation 403 may likewise be executed by the processor 310 using instructions stored in memory 320 to produce discrete measurement outcomes consistent with multinomial sampling. However, as indicated by the blocked gradient flow 405, the processor 310 is unable to propagate gradients through the multinomial sampling operation 403 due to its non-differentiable nature. Consequently, although the system can accurately model shot noise using exact multinomial sampling, the computational pipeline implemented by the processor 310 does not support gradient-based optimization when this sampling step is included. This limitation arises despite the otherwise differentiable processing capabilities of the system and motivates the use of alternative noise modeling techniques that preserve gradient flow.

Simulating the effects of shot noise on state vector simulation involves sampling from a multinomial distribution. If the state vector being measured is given as: |Ψ>Σᵢ a₁|i>then letting pᵢ=|aᵢ|², the distribution of n shots follows y~Multinomial (n, p). However, it should be noted that in the context of machine learning, sampling naively is not a differentiable operation with respect to its arguments (i.e., the probability vector p) and blocks the gradient from reaching the parameterized circuit during backpropagation, as shown in FIG. 4.

This approach reflects the real-world behavior of quantum measurements, where repeated observations (i.e., finite “shots”) of a quantum system yield discrete outcomes governed by a probability distribution defined by the quantum state's wavefunction. In such simulations, the multinomial distribution models the probability of obtaining each possible measurement result over a given number of trials. While this method 400 provides an accurate statistical representation of measurement noise, it introduces a limitation when used in differentiable computation pipelines.

Specifically, the sampling process (e.g., represented as the sample multinomial 403) is not differentiable. This is because sampling from a multinomial (or any discrete) distribution introduces randomness and discontinuities that break the assumptions of smooth, continuous mappings required for gradient-based optimization. As a result, the method 400 does not support gradient propagation through it. In the context of machine learning, where backpropagation is used to update parameters based on computed gradients, this non-differentiable step obstructs the gradient flow 405 through the computational graph.

The simulated quantum circuit 401 in example 400 represents the part of the system that contains trainable parameters, such as those defining the quantum circuit (e.g., rotation angles in parameterized gates). These are the parameters of interest during training. However, due to the insertion of the non-differentiable sample multinomial 403 between the model output and the parameters, gradients 405 cannot flow backward to the simulated quantum circuit 401 during optimization. Consequently, this setup prevents the use of standard gradient-based methods to train or optimize the quantum model when realistic shot noise is included via direct multinomial sampling.

Accordingly, this limitation motivates the need for alternative approaches that preserve differentiability while still modeling the statistical effects of shot noise—such as the reparameterization-based Gaussian approximation shown in example 500 of FIG. 5.

FIG. 5 illustrates a diagram of approximately simulating shot noise from a quantum circuit via reparameterization using the infinite shot count limit distribution in accordance with aspects of this disclosure. Specifically, example 500 of FIG. 5 presents an alternative approach to simulating shot noise in quantum circuits that enables gradient-based optimization by preserving differentiability. In contrast to the non-differentiable multinomial sampling approach described in connection with FIG. 4, the system of FIG. 5 enables gradient-based optimization by replacing discrete sampling with a continuous stochastic model.

As an example, referring back to FIGS. 1-3, the differentiable shot noise simulation techniques described herein may be implemented within the hybrid quantum-classical computing environment of the QIP system 200. In particular, execution of the parameterized quantum circuit 501 may be performed using quantum processing resources, such as the QPU 310c and trap 270, under the control of the general controller 205 and optical and trap controller 220, while classical computation—including preprocessing, loss evaluation, and gradient-based optimization—is carried out by the processor 310 in conjunction with memory 320. In addition, the reparameterized noise modeling and associated gradient propagation mechanisms may be integrated into the algorithms component 210 and executed as part of the overall software and control stack of the QIP system 200. Through coordinated operation of these components, the system enables end-to-end differentiable training across both classical and quantum subsystems, allowing realistic quantum noise effects to be incorporated into the computational pipeline without interrupting gradient flow.

In particular, the system employs a continuous approximation of the multinomial distribution corresponding to the infinite-shot limit. As the number of measurement shots increases, the multinomial distribution converges in distribution to a multivariate Gaussian. Accordingly, the system approximates shot noise using a multivariate Gaussian distribution characterized by a covariance matrix Σ derived from the underlying probability distribution of measurement outcomes. The covariance matrix may be defined as Σ₍ᵢⱼ₎=(1/N)(pᵢδᵢⱼ−pᵢpⱼ), where pᵢ denotes the probability of the i-th outcome, δᵢⱼ is the Kronecker delta, and N represents the number of measurement shots.

To preserve differentiability, the system utilizes a reparameterization mechanism in which stochastic noise is expressed as a deterministic transformation of an auxiliary random variable. Specifically, a noise vector ε is generated as ε=g(θ, z), where z is sampled from a standard normal distribution and treated as independent of the trainable parameters θ. Consistent with a count-space formulation, a noisy measurement count vector is first constructed as ĉ=N·p(θ)+ε, where N denotes the shot count and p(θ) represents the underlying probability vector derived from the simulated quantum state. This count-space representation is then normalized to obtain an approximate noisy measurement distribution \tilde{y}=ĉ/N. Because z is treated as constant during differentiation, gradients propagate through p(θ) without obstruction, thereby preserving differentiability while modeling shot noise in a manner consistent with the count-based measurement process.

As shown in FIG. 5, the system architecture separates the stochastic noise generation from the primary computational path associated with the parameterized quantum circuit 501. The circuit produces a probability vector (or corresponding expected measurement counts), and sampled Gaussian noise (e.g., sample multivariate Gaussian 503) is incorporated via an additive operation 507 applied in the measurement output space-specifically to the count or probability representation derived from the circuit, rather than to the quantum state vector itself. This additive formulation ensures that noise modeling remains compatible with differentiation, allowing gradients 505 to propagate backward through the computational graph to the trainable parameters of the simulated quantum circuit 501 without obstruction.

In some embodiments, alternative continuous distributions (e.g., Laplace or Dirichlet distributions) may be employed to approximate shot noise, depending on system requirements. However, the multivariate Gaussian distribution provides an effective approximation under high-shot conditions due to convergence properties described by the central limit theorem.

In certain implementations, the system may further include a dual-path configuration. A differentiable path employing the Gaussian approximation may be used during training to enable gradient-based optimization, while a parallel non-differentiable path utilizing exact multinomial sampling may be used during evaluation to preserve physical accuracy. These paths may operate concurrently or be selectively activated depending on the operational phase.

Following noise injection, the resulting measurement-output representation may be subjected to a rectification process to ensure compliance with probabilistic constraints. For example, a noisy measurement count or probability vector may be adjusted to enforce non-negativity and normalized such that its elements sum to one, thereby forming a valid probability distribution. Observables may then be computed from this rectified measurement-output distribution, and a loss function may be evaluated for use in updating the circuit parameters via gradient-based optimization.

Advantageously, the system of FIG. 5 enables incorporation of realistic noise effects into quantum circuit simulation while maintaining full compatibility with gradient-based learning frameworks. This allows training using standard optimization techniques, including stochastic gradient descent and adaptive optimizers, and improves generalization performance when models are deployed on noisy quantum hardware.

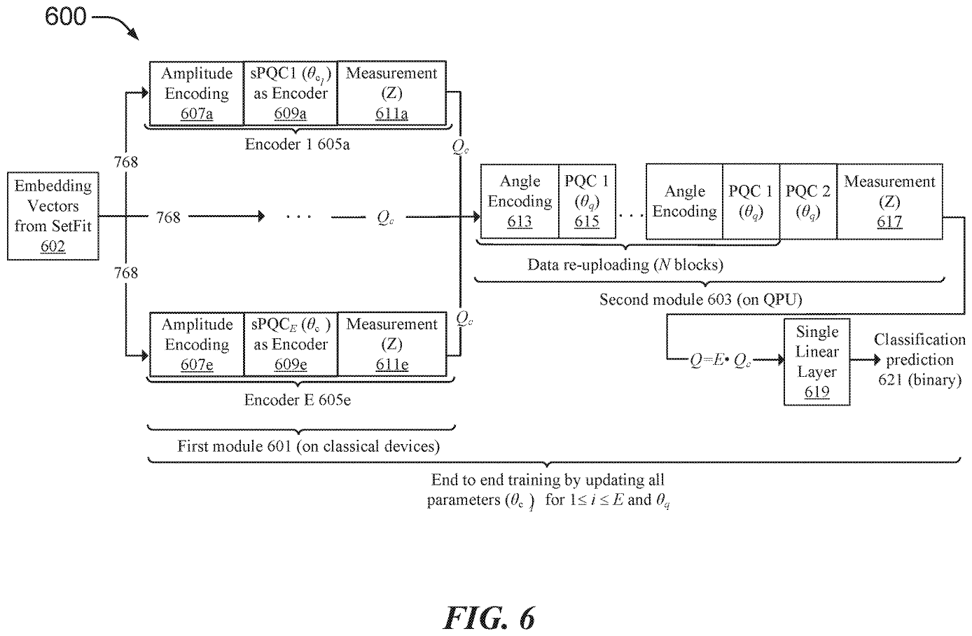

FIG. 6 illustrates a block diagram of a hybrid quantum-classical architecture for fine-tuning a large language model (LLM) using a parameterized quantum circuit in accordance with aspects of this disclosure. Specifically, the architecture 600 operates as a classification head appended to the output of the pre-trained model and is structured as an end-to-end differentiable pipeline comprising a classical processing module and a quantum processing module.

Referring back to FIGS. 1-3, the hybrid quantum-classical architecture 600 may be implemented within the QIP system 200 and computer device 300, where classical operations of the first module 601 (including encoders 605a-605e, amplitude encoding components 607a-607e, and simulated circuits 609a-609e) are executed by the processor 310 and coordinated by the algorithms component 210 to generate latent representations from input embeddings 602. The second module 603 may be executed on quantum hardware, including the QPU 310c and trap 270, under control of the general controller 205 and optical and trap controller 220, with encoding 613, circuit execution 615, and measurements 617 performed via quantum operations and read out through the imaging system 230. In this way, differentiable noise modeling may be integrated into this framework to enable coordinated classical-quantum execution, supporting end-to-end gradient-based optimization with noise-aware training while preserving gradient flow.

The architecture 600 receives, as input, high-dimensional embedding vectors 602 generated by the pre-trained language model. In some embodiments, such embeddings may have dimensionality on the order of hundreds (e.g., 768-dimensional vectors). These embeddings 602 are processed by a first module 601 implemented on one or more classical computing devices. The first module 601 includes a plurality of parallel encoders 605a . . . 605e, each configured to transform the input embedding into a reduced-dimensional latent representation.

Each encoder may include a simulated amplitude encoding component 607a, . . . 607e and a simulated parameterized quantum circuit (sPQC) 609a, . . . 609e having trainable parameters θ_c. The amplitude encoding component maps a classical input vector x into a quantum state representation such that |ψ=Σᵢ xᵢ|i [symbol] . Because the first module 601 is executed on classical hardware, this encoding may be performed directly without requiring physical quantum state preparation. The sPQC 609a, . . . 609e processes the encoded state and produces measurement outputs 611a, . . . 611e (e.g., expectation values of Pauli-Z operators), which collectively form a latent feature vector. This transformation reduces the dimensionality of the input embedding to a dimension proportional to the number of classical qubits Q_c.

The use of multiple encoders 605a, . . . 605e provides improved computational efficiency and scalability. Specifically, distributing the encoding across m encoders each operating on M qubits yields a memory complexity of O(m·2\hat{ }M), which is more tractable than the O(2\hat{ }(mM)) complexity associated with a single large encoder. Additionally, the multi-encoder configuration increases model capacity through parameterization rather than relying solely on exponential Hilbert space growth, thereby improving classification performance.

The second module 603 of the architecture 600 is executed on a quantum processing unit (QPU) and receives as input the latent vectors generated by the first module 601. These latent vectors are encoded into quantum states using an angle encoding scheme, wherein each data element determines the rotation angle of a corresponding single-qubit gate (e.g., RY rotations). This encoding maps classical data into quantum states by rotating qubits on the Bloch sphere, thereby embedding information into quantum amplitudes and phases.

The second module 603 further includes a data re-uploading mechanism comprising a plurality of re-uploading blocks. Each block applies the encoding operation 613 followed by a parameterized quantum circuit (PQC) 615 with trainable parameters θ_q. The PQC 615 may implement a hardware-aware ansatz with configurable qubit connectivity, including long-range entangling operations supported by certain quantum hardware platforms. Repeated application of encoding and circuit layers enhances the expressive capacity of the model by allowing complex feature transformations within the quantum domain.

Following processing by the PQC, measurement operations 617 are performed on the qubits to obtain observable values (e.g., expectation values of Pauli-Z operators). These outputs are provided to a classical post-processing layer 619 (e.g., a linear transformation), which produces prediction logits corresponding to the classification task 621. Both the classical and quantum modules are differentiable, enabling joint optimization of parameters θ_c and θ_q through backpropagation.

In some embodiments, the architecture 600 incorporates noise-aware training techniques as described herein. In particular, the system replaces non-differentiable multinomial sampling of measurement outcomes with a differentiable approximation based on reparameterized continuous distributions. Noise samples are generated as differentiable functions of the circuit parameters and auxiliary random variables and are additively applied to measurement outputs derived from the simulated quantum state. This approach enables gradients to propagate through the noise model while preserving realistic simulation of shot noise.

The incorporation of differentiable noise modeling provides several technical advantages. First, it enables training under realistic noise conditions, improving generalization when deployed on physical quantum hardware. Second, it preserves compatibility with standard gradient-based optimization techniques, avoiding computationally expensive sampling-based gradient estimation. Third, the modular noise injection framework allows integration into existing training pipelines without requiring structural modifications to the quantum circuit or learning architecture.

Accordingly, the architecture 600 facilitates efficient and scalable end-to-end training across heterogeneous classical and quantum computing resources, while maintaining robustness to noise and enabling practical deployment in near-term quantum computing environments.

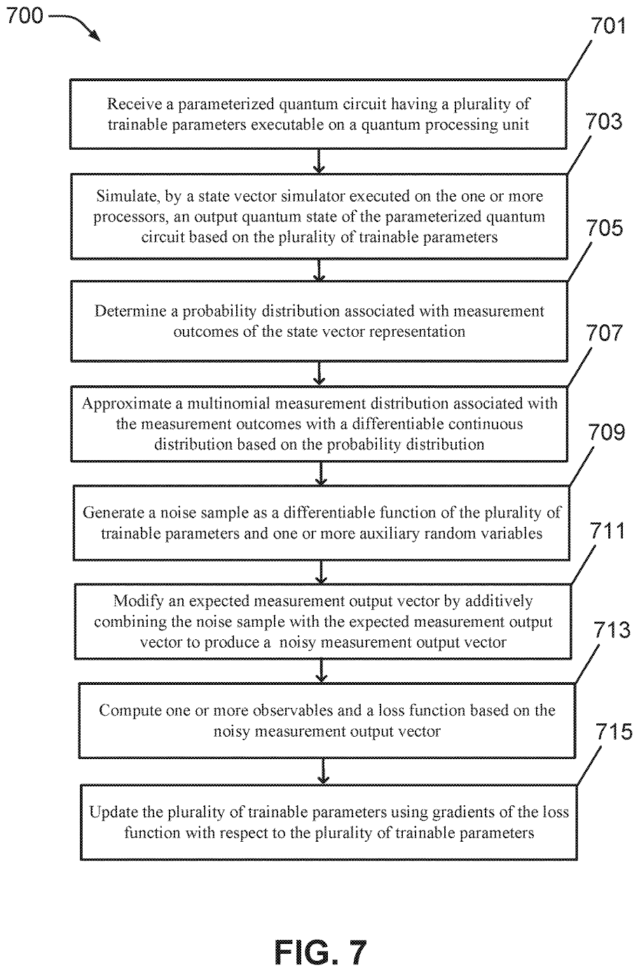

FIG. 7 illustrates a method for differentiably simulating the multinomial distributed shot noise at high shot counts in accordance with aspects of this disclosure. In general, it is noted that the exemplary method 700 can be implemented using the components and systems described herein, especially with reference to QIP system 200 and general controller 205 of FIG. 2 as described above and system 800 and computing device 802 of FIG. 8 as described below. The steps and algorithms described in relation to process 700 may be executed by processor 310 using the algorithms components 210. In some implementations, the process 700 is performed by a processor executing code stored in a non-transitory computer-readable storage medium (e.g., a memory). At a high level, the method 700 describes training a parameterized quantum circuit using noise-aware, differentiable simulation and gradient-based optimization.

At 701, the method 700 may include receiving, by one or more processors, a parameterized quantum circuit having a plurality of trainable parameters executable on a QPU. The parameterized quantum circuit may define a sequence of quantum gate operations, such as rotation gates (e.g., RY or RZ rotations), whose behavior is controlled by the trainable parameters (e.g., rotation angles), and the one or more processors may load or instantiate a computational representation of the circuit structure along with initial or current values of the trainable parameters into memory for subsequent simulation. By receiving the parameterized quantum circuit as a structured, machine-readable input, the method 700 enables efficient downstream simulation and gradient-based optimization without requiring access to physical quantum hardware at this stage, thereby facilitating rapid prototyping and iterative training of quantum machine learning models within a classical or hybrid computing environment.

At 703, the method 700 may include simulating, by a state vector simulator executed on the one or more processors, an output quantum state of the parameterized quantum circuit based on the plurality of trainable parameters. The output quantum state may be represented as a state vector representation. As used herein, the term “state vector representation” refers to a complex-valued vector ψ(θ) in a Hilbert space whose elements correspond to quantum amplitudes and whose squared magnitudes define measurement probabilities. The term “modified state vector” refers to a perturbed vector ψ′=ψ(θ)+ε, where ε is a noise vector generated via a differentiable transformation, and optionally a normalized vector ψ″=ψ′/∥ψ′∥ that satisfies a unit-norm constraint associated with valid quantum states. The state vector simulator updates the quantum state step by step by applying unitary matrix operations for each gate in the circuit. The trainable parameters, such as rotation angles, define these matrices. The final state vector contains complex amplitudes, and the squared magnitude of each amplitude gives the probability of measuring that state. By running this simulation on classical hardware using a state vector, method 700 keeps a full and exact description of the quantum state. This allows it to accurately compute measurement probabilities, expectation values, and their gradients with respect to trainable parameters, enabling efficient, noise-aware optimization without needing repeated runs on actual quantum hardware.

At 705, the method 700 may include determining, by the one or more processors, a probability distribution associated with measurement outcomes of the state vector representation. The processors compute the squared magnitudes of the complex amplitudes in the state vector to obtain the probability of each possible measurement outcome, following the Born rule. The Born rule means that each measurement outcome's probability is obtained by squaring the magnitude of its corresponding complex amplitude in the state vector. This step is useful because it turns the quantum state into a clear classical probability distribution. That distribution can then be used for noise modeling and differentiable approximations, allowing the training process to work with measurement statistics without needing to run on actual quantum hardware.

At 707, the method 700 may include approximating a multinomial measurement distribution associated with the measurement outcomes with a differentiable continuous distribution based on the probability distribution. As used herein, the term “differentiable continuous distribution” refers to a parameterized probability distribution having a continuous support and a probability density function that is differentiable with respect to the trainable parameters θ, including but not limited to multivariate Gaussian, Laplace, or Dirichlet distributions whose parameters (e.g., mean and covariance) are functions of θ. In certain implementations, the differentiable continuous distribution comprises a multivariate Gaussian distribution with mean vector p(θ) and covariance matrix Σ(p(θ)) derived from measurement probabilities.

The processors are configured to replace a discrete, non-differentiable multinomial sampling operation, which would otherwise inhibit gradient propagation, with a continuous surrogate distribution that approximates the statistical behavior of the multinomial distribution under high shot-count conditions. The continuous surrogate is constructed to retain the essential noise characteristics associated with quantum measurement processes while introducing differentiability across the computational pipeline. By enabling gradients to propagate through the sampling stage, the disclosed approach supports the application of gradient-based optimization techniques, including backpropagation, in an end-to-end training framework, thereby improving parameter optimization efficiency while maintaining consistency with realistic measurement noise.

In some aspects, the differentiable continuous distribution may include a multivariate Gaussian distribution having a covariance matrix derived from the probability distribution associated with the measurement outcomes. The processors are configured to construct a multivariate Gaussian distribution having a mean vector and covariance matrix derived directly from the measurement probabilities, such that, in the limit of large shot counts, the Gaussian distribution approximates the multinomial distribution in accordance with the central limit theorem. The construction of the Gaussian distribution is continuous and differentiable, thereby enabling the application of reparameterization techniques for efficient gradient computation. Additionally, the covariance structure is defined to capture correlations among measurement outcomes, allowing the approximation to preserve statistically relevant dependencies while supporting gradient-based optimization within the computational pipeline.

In some aspects, the covariance matrix may be defined based on multinomial variance as a function of the probability distribution and a number of measurement samples. The processors are configured to compute covariance matrix entries according to

$${Σ}_{ij} = \frac{1}{N} ( {p}_{i} {δ}_{ij} - {p}_{i} {p}_{j} ) ,$$

where pᵢ denotes the measurement probability associated with outcome i, N denotes the number of measurement shots, and δᵢⱼ denotes the Kronecker delta. This computation yields a covariance matrix that is rank-deficient, reflecting the normalization constraint that the probabilities collectively sum to one. By defining the covariance this way, the noise level is directly determined by meaningful physical quantities, such as the measurement probabilities and the number of shots. This ensures that the noise model accurately reflects how a real quantum device behaves when measurements are repeated a finite number of times.

In some aspects, the differentiable continuous distribution may be selected from the group consisting of Gaussian, Laplace, and Dirichlet distributions. The processors are configured to implement multiple continuous distributions that provide distinct relaxations of a discrete multinomial sampling process. In particular, a Gaussian distribution may be employed to provide a symmetric approximation suitable for high shot-count regimes, a Laplace distribution may be utilized to model heavier-tailed behavior associated with lower shot counts, and a Dirichlet distribution may be applied to enforce the simplex constraint that probabilities sum to one. This configurable framework enables selection or adaptation of the noise approximation based on the noise profile and shot-count conditions of a target quantum device. By aligning the chosen distribution with the underlying measurement characteristics, the disclosed approach improves the fidelity of the training process across a range of experimental operating conditions.

At 709, the method 700 may include generating a noise sample as a differentiable function of the plurality of trainable parameters and one or more auxiliary random variables. As used herein, the term “differentiable function” refers to a deterministic mapping g(θ, z) that is continuously differentiable with respect to θ for almost all values of an auxiliary random variable z, where z is sampled from a parameter-independent base distribution (e.g., z~N(0, I)). In some embodiments, the noise sample is constructed to match the covariance structure of multinomial shot noise in a measurement-output (count or probability) space. Because the multinomial covariance matrix is rank-deficient, direct factorization (e.g., via Cholesky decomposition) is generally inapplicable without modification. Accordingly, in a primary embodiment, the system employs a Householder reflection-based transformation that maps the auxiliary variable zinto a subspace consistent with the multinomial constraints, thereby generating samples with the desired covariance structure without explicitly forming or factorizing the covariance matrix. The processors are configured to generate auxiliary random variables zfrom a fixed, parameter-independent distribution and to apply a deterministic, differentiable transformation (e.g., the Householder-based mapping) that produces a noise sample with statistical properties corresponding to a target shot noise model. This reparameterization separates the stochastic source from the trainable parameters, enabling gradient propagation through the noise generation process during backpropagation while preserving the stochastic characteristics of quantum measurement noise for realistic and efficient optimization.

In some aspects, generating the noise sample comprises applying a reparameterization technique that expresses the noise sample as a deterministic transformation of a standard normal random variable and the plurality of trainable parameters, such that the noisy measurement output vector is maintained within a differentiable computational graph configured to propagate gradients through the noise sample to the plurality of trainable parameters. The processors are configured to sample an auxiliary random variable z from a standard normal distribution [symbol] (0, I) and to compute a corresponding noise sample ε=g(θ,z), where g is a deterministic transformation. In certain implementations, the transformation g comprises a linear mapping based on a decomposition of a parameter-dependent covariance matrix, such as a Cholesky decomposition, to shape the noise in accordance with the desired statistical structure. Because the auxiliary variable z is independent of the trainable parameters θ, it is treated as constant during differentiation, thereby enabling analytical computation of the gradient ∂ε/∂θ. This formulation preserves differentiability across the computational graph and facilitates efficient application of stochastic gradient descent-based optimization techniques.

At 711, the method 700 may include modify, by the one or more processors, an expected measurement output vector by additively combining the noise sample with the expected measurement output vector to produce a noisy measurement output vector. The expected measurement output vector may be derived from the probability distribution scaled by a number of measurement shots. As used herein, the term “differentiable computational graph” refers to a directed acyclic graph of computational operations in which each node corresponds to a differentiable function and edges represent data dependencies, such that gradients of a scalar loss function with respect to the trainable parameters are computable via application of the chain rule using automatic differentiation techniques, including reverse-mode backpropagation. The processors are configured to perform an element-wise vector addition between a measurement output representation—such as a count vector or probability distribution derived from the simulated quantum state—and a generated noise sample, thereby introducing a perturbation that simulates the effects of finite-shot measurement noise at the measurement-output level rather than at the state vector level. This additive noise injection preserves the structure of the differentiable computational graph, allowing gradients with respect to the trainable parameters to propagate through the quantum circuit simulation and the subsequent measurement-output transformation. As a result, the system supports noise-aware parameter updates within a unified backpropagation process.

In some aspects, modifying the expected measurement output vector may include additively combining the noise sample with the output quantum state via vector addition. The processors are configured to modify an expected measurement output vector by additively combining a generated noise sample with a measurement-output representation p(θ) derived from the quantum state, thereby generating a perturbed output \tilde{p}=p(θ)+ε that reflects statistical fluctuations associated with finite measurement sampling. This element-wise additive operation is computationally efficient and avoids introducing nonlinear transformations that could impede gradient computation. Moreover, because the perturbation is applied after the state-to-measurement mapping, the formulation preserves gradient flow from a loss function through the measurement-output representation and back to the underlying circuit parameters, thereby supporting stable and efficient gradient-based optimization.

At 713, the method 700 may include computing one or more observables and a loss function based on the noisy measurement output vector. The processors are configured to evaluate quantum mechanical expectation values by computing inner products of the form [symbol] ψ″|Ô|ψ″ [symbol] , where Ô represents an observable operator, including but not limited to a Pauli operator or a Hamiltonian, and ψ″ denotes a modified and, in certain implementations, normalized state vector. The computed expectation values are then used to determine a scalar loss function that quantifies a deviation between the noise-affected output of the quantum circuit and a corresponding target value. By mapping the perturbed measurement-output representation to a differentiable scalar objective, this operation enables gradient-based optimization techniques to be applied while accounting for the impact of shot noise on circuit performance.

In some aspects, computing the one or more observables may include evaluating an expectation value of an observable operator with respect to the modified expected measurement output vector. The processors are configured to perform matrix-vector multiplications and corresponding inner product operations to compute expectation values of the form [symbol] ψ″|Ô|ψ″ [symbol] for one or more observable operators Ô, wherein the modified state vector ψ″ incorporates effects of simulated shot noise. The expectation value computation is continuous and differentiable with respect to the underlying probability representation, thereby enabling efficient evaluation of gradients of an associated loss function. These gradients may be propagated through the entire noise-aware simulation pipeline, supporting end-to-end optimization of the underlying trainable parameters.

At 715, the method 700 may include updating the plurality of trainable parameters using gradients of the loss function with respect to the plurality of trainable parameters. The gradients may be computed via backpropagation through the differentiable continuous distribution. As used herein, the phrase “backpropagation through the differentiable continuous distribution” refers to computing gradients of a loss function L with respect to trainable parameters θ by applying the chain rule through a reparameterized stochastic computation in which a noise sample is expressed as ε=g(θ, z), where z is treated as constant during differentiation. In this formulation, gradient contributions are propagated through both the probability distribution p(θ) and the transformation g(θ, z), such that ∂L/∂θ is computed without differentiating through the random sampling operation itself. In some implementations, this includes computing gradients through the covariance-dependent transformation defining ε, thereby enabling end-to-end gradient flow through the noise model within the training pipeline. The processors are configured to traverse a computational graph in reverse order and to apply the chain rule to compute partial derivatives of a loss function with respect to each trainable parameter. A differentiable continuous noise approximation, in combination with a reparameterization technique, preserves continuity of the gradient path from the loss function through noise injection, state vector simulation, and corresponding circuit parameters. This configuration enables implementation of standard gradient-based optimization algorithms, including but not limited to Adam and stochastic gradient descent (SGD), for noise-aware training. Additionally, the approach reduces computational overhead relative to sampling-based gradient estimation techniques, such as the parameter-shift rule, while producing parameter updates that incorporate effects of realistic shot noise.

In some aspects, the noisy measurement output vector is derived by: scaling the probability distribution derived from the state vector representation by the number of measurement shots to obtain an expected count vector, adding a reparameterized Gaussian noise vector to the expected count vector, and rectifying and normalizing the resulting vector such that entries of the resulting vector sum to one. In some aspects, the noisy measurement output vector is derived through a sequence of operations performed in a measurement-output (count and probability) space. First, a probability distribution p(θ) is computed from the simulated quantum state vector, and this distribution is scaled by a specified number of measurement shots N to obtain an expected count vector c=N·p(θ), which represents the mean outcome of a finite-shot sampling process. Next, a reparameterized Gaussian noise vector E, constructed to approximate the covariance structure of multinomial shot noise, is additively combined with the expected count vector to produce a perturbed count vector \tilde{c}=c+ε. This step introduces stochastic variability consistent with finite sampling while remaining differentiable with respect to the underlying parameters. The resulting perturbed count vector is then subjected to a rectification process to enforce physical constraints, including ensuring non-negative entries (e.g., via clipping or smooth approximations thereof). Finally, the rectified vector is normalized by the total shot count or its adjusted sum to produce a noisy measurement-output probability vector \tilde{p} whose elements sum to one. This normalized representation may then be used for downstream observable estimation and loss evaluation within a differentiable optimization pipeline.

In some aspects, the method 700 may further include evaluating the parameterized quantum circuit by: executing a differentiable continuous approximation in a training mode; and executing a non-differentiable multinomial sampling process in an inference mode. In the training mode, the system computes measurement probabilities from the simulated state and applies a differentiable continuous approximation of shot noise in the measurement-output space, enabling gradient-based optimization via backpropagation. In the inference mode, the system performs non-differentiable multinomial sampling from the same probability distribution to generate discrete measurement outcomes consistent with physical quantum measurements. This dual-mode operation provides the advantage of efficient and stable training using differentiable approximations, while preserving physical realism during inference by producing statistically accurate, shot-noise-limited outputs.

In some aspects, updating the plurality of trainable parameters may be performed using the differentiable continuous approximation, and evaluation of the parameterized quantum circuit is performed using the multinomial sampling process. The processors are configured, during each training iteration, to compute gradients with respect to trainable parameters via a differentiable approximation path and to update the parameters using gradient-based optimization. In addition, the processors are further configured to execute, periodically or concurrently, a separate evaluation path that performs discrete sampling from a multinomial distribution to assess circuit performance under stochastic measurement conditions without incurring gradient computation overhead. This separation enables the training process to utilize smooth and low-variance gradient estimates provided by the continuous approximation, while the evaluation path yields performance metrics that reflect discrete stochastic behavior expected during operation on physical quantum hardware. As a result, the disclosed approach improves reliability of training outcomes and facilitates transfer of optimized parameters to quantum processors operating under realistic noise conditions.

The disclosed systems and methods provide significant technical advantages in the field of quantum machine learning by enabling differentiable modeling of quantum shot noise within hybrid quantum-classical frameworks. By replacing non-differentiable multinomial sampling with a continuous, reparameterized noise approximation, the invention preserves gradient flow through stochastic quantum processes, allowing efficient use of standard gradient-based optimization techniques such as stochastic gradient descent and Adam. This eliminates the need for computationally expensive sampling-based gradient estimators while maintaining fidelity to realistic quantum noise characteristics. Additionally, incorporating noise during training improves model robustness and generalization when deployed on real quantum hardware, where measurement noise is inherent. The approach further supports scalable simulation and training by leveraging classical-quantum interoperability, enabling end-to-end optimization across heterogeneous computing systems without requiring structural modifications to existing quantum circuits or learning pipelines.

It is understood that the method illustrated by FIG. 7 is exemplary in nature and that the steps described herein may be combined or modified to generate alternative embodiments.

FIG. 8 illustrates an example of a QIP system in accordance with aspects of this disclosure. The example QIP system 800 shown in FIG. 8 includes a control subsystem 810 that can receive a quantum program 804 from a computing device 802 that is remotely located relative to the example QIP system 800 and is functionally coupled (e.g., communicatively coupled) to the control subsystem 810. The computing device 802 can send data defining the quantum program 804 to control subsystem 810 for execution in quantum hardware 820, simulating shot noise from a quantum circuit, as described herein. As is indicated by dashed lines, the computing device 802 can be external to the example QIP system 800. For example, the computing device 802 can be a user device (e.g., a classical computer) of an end-user of the QIP system 800. The control subsystem 810 can retain the quantum program 804 in one or more memory devices 812. The quantum program 804 corresponds to a defined quantum computation. The defined quantum computation can be an n-qubit computation, for example. The quantum program 804 can include a quantum circuit (and, in some cases, sub-circuits, such as the simulation component, probability distribution component, approximation component, noise sample generation component, state vector representation component, and parameter update component) representing a quantum algorithm associated with the quantum computation. Examples of the quantum algorithm include a variational quantum algorithm, a machine-learning algorithm, a Fourier transform algorithm, or the like.

The control subsystem 810 can be functionally coupled to quantum hardware 820 via multiple links 814 that permits the exchange of data and/or controls signal between the control subsystem 810 and the quantum hardware 820. The quantum hardware 820 can embody or can include one or more quantum computers. In some cases, the quantum hardware 820 embodies a cloud-based quantum computer. In other cases, the quantum hardware 820 embodies, or includes a local quantum computer. Regardless of its spatial footprint, the quantum hardware 820 includes multiple qubits 830 arranged in a particular layout. Each qubit of the qubits 830 (including the target and ancilla qubits described herein) can be coupled to an environment and/or to one another. Such coupling(s) decoheres and relaxes quantum information contained in the qubit. Thus, the quantum hardware 820 can be noisy. The type of the multiple links can be based on the type of qubits 830 used by the quantum hardware 820 for computation. In some cases, the multiple links 814 can include wireline links or optical links, or a combination of both. In other cases, the multiple links 814 can include microwave resonator devices or microwave transmission lines, or a combination of both.

The qubits 830 can include atomic qubits assembled in an atom-trap. Thus, the atomic qubits can be referred to as trapped-atom qubits. In some cases, each one of the atomic qubits can be a neutral atom. In other cases, each one of the atomic qubits can be an ion, such as an Ytterbium ion, a calcium ion, or similar ions. The atomic-qubits in such cases can be confined within an ion-trap (e.g., the trap 270 (FIG. 2) and can be assembled in a linear arrangement (such as the linear crystal or chain 110 (FIG. 1)). In other implementations, the qubits 830 can include solid-state devices of one of several types. Such devices can be embodied in, for example, Josephson junction devices, semiconductor quantum-dots, or defects in a semiconductor material (such as vacancies in Si and Ge, or nitrogen-vacancy centers in diamond).

The control subsystem 810 can cause the quantum hardware 820 to execute the quantum circuit and/or sub-circuits as described herein. In response, the control subsystem 810 can receive measurement data 818 indicative of computation outputs that includes the output of gradient-based optimization of quantum machine learning models, for example. Because the quantum computation can be performed in two or more qubits, a measurement outcome can be represented as a bitstring representing a particular target output state given a particular set of qubits involved in a quantum computation. The control subsystem 810 can supply at least a portion of the measurement data 818 to components of the control subsystem 810 and/or other subsystems (e.g., post-processing subsystem 850).

The control subsystem 810 also can be functionally coupled to a post-processing subsystem 850 via a communication architecture 840. The communication architecture 840 can include wirelines links, wireless links, network devices (such as gateway devices, servers, and the like), or a combination thereof. The post-processing subsystem 850 can apply one or several post-processing techniques to measurement data 818 received from the quantum hardware 820. By applying such techniques, the post-processing subsystem 850 can generate a result 854 of a gradient-based optimization of quantum machine learning models executed by the quantum hardware. The post-processing subsystem 850 can send the result 854 (or data indicative of the result 854) to the computing device 802 and/or other computing device(s) 858. The post-processing subsystem 850 also can cause the computing device 802 to present the result 854 in a particular way. For example, the post-processing subsystem 850 can direct the computing device 802 to present a user interface including the result 854.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

In general, it is noted that the foregoing description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method for training a parameterized quantum circuit using noise-aware optimization, the method comprising:
receiving, by one or more processors, a parameterized quantum circuit having a plurality of trainable parameters executable on a quantum processing unit (QPU);
simulating, by a state vector simulator executed on the one or more processors, an output quantum state of the parameterized quantum circuit based on the plurality of trainable parameters, wherein the output quantum state is represented as a state vector representation;
determining, by the one or more processors, a probability distribution associated with measurement outcomes of the state vector representation;
approximating a multinomial measurement distribution associated with the measurement outcomes with a differentiable continuous distribution based on the probability distribution;
generating a noise sample as a differentiable function of the plurality of trainable parameters and one or more auxiliary random variables;
modifying, by the one or more processors, an expected measurement output vector by additively combining the noise sample with the expected measurement output vector to produce a noisy measurement output vector, wherein the expected measurement output vector is derived from the probability distribution scaled by a number of measurement shots;
computing one or more observables and a loss function based on the noisy measurement output vector; and
updating the plurality of trainable parameters using gradients of the loss function with respect to the plurality of trainable parameters, wherein the gradients are computed via backpropagation through the differentiable continuous distribution.

2. The method of claim 1, wherein the differentiable continuous distribution comprises a multivariate Gaussian distribution having a covariance matrix derived from the probability distribution associated with the measurement outcomes.

3. The method of claim 2, wherein the covariance matrix is defined based on multinomial variance as a function of the probability distribution and a number of measurement samples.

4. The method of claim 1, wherein generating the noise sample comprises applying a reparameterization technique that expresses the noise sample as a deterministic transformation of a standard normal random variable and the plurality of trainable parameters, such that the noisy measurement output vector is maintained within a differentiable computational graph configured to propagate gradients through the noise sample to the plurality of trainable parameters.

5. The method of claim 1, wherein modifying the expected measurement output vector comprises additively combining the noise sample with the output quantum state via vector addition.

6. The method of claim 1, wherein the noisy measurement output vector is derived by:
scaling the probability distribution derived from the state vector representation by the number of measurement shots to obtain an expected count vector,
adding a reparameterized Gaussian noise vector to the expected count vector, and
rectifying and normalizing the resulting vector such that entries of the resulting vector sum to one.

7. The method of claim 1, wherein computing the one or more observables comprises evaluating an expectation value of an observable operator with respect to the modified expected measurement output vector.

8. The method of claim 1, wherein the differentiable continuous distribution is selected from a group consisting of Gaussian, Laplace, and Dirichlet distributions.

9. The method of claim 1, wherein evaluating the parameterized quantum circuit comprises: executing a differentiable continuous approximation in a training mode; and executing a non-differentiable multinomial sampling process in an inference mode.

10. The method of claim 9, wherein updating the plurality of trainable parameters is performed using the differentiable continuous approximation, and evaluation of the parameterized quantum circuit is performed using the non-differentiable multinomial sampling process.

11. A system for training a parameterized quantum circuit using noise-aware optimization, comprising:
one or more processors; and
a memory storing instructions that, when executed by the one or more processors, cause the system to:
receive, by one or more processors, a parameterized quantum circuit having a plurality of trainable parameters executable on a quantum processing unit (QPU),
simulate, by a state vector simulator executed on the one or more processors, an output quantum state of the parameterized quantum circuit based on the plurality of trainable parameters, wherein the output quantum state is represented as a state vector representation,
determine, by the one or more processors, a probability distribution associated with measurement outcomes of the state vector representation,
approximate a multinomial measurement distribution associated with the measurement outcomes with a differentiable continuous distribution based on the probability distribution,
generate a noise sample as a differentiable function of the plurality of trainable parameters and one or more auxiliary random variables,
modify, by the one or more processors, an expected measurement output vector by additively combining the noise sample with the expected measurement output vector to produce a noisy measurement output vector, wherein the expected measurement output vector is derived from the probability distribution scaled by a number of measurement shots,
compute one or more observables and a loss function based on the noisy measurement output vector, and
update the plurality of trainable parameters using gradients of the loss function with respect to the plurality of trainable parameters, wherein the gradients are computed via backpropagation through the differentiable continuous distribution.

12. The system of claim 11, wherein the differentiable continuous distribution comprises a multivariate Gaussian distribution having a covariance matrix derived from the probability distribution associated with the measurement outcomes.

13. The system of claim 12, wherein the covariance matrix is defined based on multinomial variance as a function of the probability distribution and a number of measurement samples.

14. The system of claim 11, wherein generating the noise sample comprises applying a reparameterization technique that expresses the noise sample as a deterministic transformation of a standard normal random variable and the plurality of trainable parameters, such that the noisy measurement output vector is maintained within a differentiable computational graph configured to propagate gradients through the noise sample to the plurality of trainable parameters.

15. The system of claim 11, wherein modifying the expected measurement output vector comprises additively combining the noise sample with the output quantum state via vector addition.

16. The system of claim 11, wherein the noisy measurement output vector is derived by:
scaling the probability distribution derived from the state vector representation by the number of measurement shots to obtain an expected count vector,
adding a reparameterized Gaussian noise vector to the expected count vector, and
rectifying and normalizing the resulting vector such that entries of the resulting vector sum to one.

17. The system of claim 11, wherein computing the one or more observables comprises evaluating an expectation value of an observable operator with respect to the modified expected measurement output vector.

18. The system of claim 11, wherein the differentiable continuous distribution is selected from a group consisting of Gaussian, Laplace, and Dirichlet distributions.

19. The system of claim 11, wherein the instructions further cause the system to evaluate the parameterized quantum circuit by: executing a differentiable continuous approximation in a training mode and executing a non-differentiable multinomial sampling process in an inference mode.

20. A hybrid classical-quantum system for training a parameterized quantum circuit using noise-aware optimization, comprising:
a classical computing system including one or more processors and memory storing instructions; and
a quantum processing unit (QPU) configured to execute the parameterized quantum circuit, wherein the classical computing system is configured to:
receive, by one or more processors, a parameterized quantum circuit having a plurality of trainable parameters executable on a quantum processing unit (QPU),
simulate, by a state vector simulator executed on the one or more processors, an output quantum state of the parameterized quantum circuit based on the plurality of trainable parameters, wherein the output quantum state is represented as a state vector representation,
determine, by the one or more processors, a probability distribution associated with measurement outcomes of the state vector representation,
approximate a multinomial measurement distribution associated with the measurement outcomes with a differentiable continuous distribution based on the probability distribution,
generate a noise sample as a differentiable function of the plurality of trainable parameters and one or more auxiliary random variables,
modify, by the one or more processors, an expected measurement output vector by additively combining the noise sample with the expected measurement output vector to produce a noisy measurement output vector, wherein the expected measurement output vector is derived from the probability distribution scaled by a number of measurement shots,
compute one or more observables and a loss function based on the noisy measurement output vector, and
update the plurality of trainable parameters using gradients of the loss function with respect to the plurality of trainable parameters, wherein the gradients are computed via backpropagation through the differentiable continuous distribution.
